(19) United States
(12) Patent Application Publication
(10) Pub. No.: US 2006/0159071 A1
(43) Pub. Date: Jul. 20, 2006

(54) Method of starting an IP station, system, server and station implementing same and method of setting up a telephone call

(75) Inventor: Arthur Monteiro, Beynes (FR)

Correspondence Address: MARSHALL, GERSTEIN & BORUN LLP, 233 S. WACKER DRIVE, SUITE 6300, SEARS TOWER, CHICAGO, IL, 60606, US

(73) Assignee: AASTRA MATRA TELECOM, Guyancourt (FR)

(21) Appl. No.: 11/304,323

(22) Filed: Dec. 15, 2005

(30) Foreign Application Priority Data
Dec. 16, 2004 (FR) FR 04 13432

(51) Int. Cl. H04L 12/66

(52) U.S. Cl. 370/352

(57) ABSTRACT

In a packet switching data transmission network on the one hand, and in a public telephone network on the other hand, a station (14) is started, the networks being interconnected via a call server (15).

The transmission network comprises an administration server (11), a plurality of subnets administered by the administration server and a plurality of stations (14), each linked to a subnet.

The administration server stores a respective location information for each subnet. A station emits a lease request (301), destined for the administration server. Then, the station receives from the administration server, in response to the lease request, a lease (302) containing the location information of the subnet of the station. Next, the station emits, destined for the call server, a registration request (304) comprising an identifier of the station as well as the location information. Then, on receipt of this request, the call server stores (305) in a call database a information associating the identifier of the station and the location information.

The present invention pertains to VoIP technology (standing for “Voice over IP” (Internet Protocol)), that is to say to telephony over IP. This technology makes it possible to set up or establish a call between a station of an IP network (called the IP station) and a telephone of a public telephone network or between two IP stations. The present invention relates more particularly to the geographical locating of an IP station in an IP network on the basis of a call.

An IP network can be divided into several different subnets for reasons of maintenance, management of the stations or security.

An IP station included in a determined subnet requires a list of parameters for its operation. Such a list of parameters forms what is called a lease. According to the current version of IP (IPv4), the list comprises parameters, such as:
a unique address on the network (IP address);
a subnet mask, which identifies the IP subnet to which the station belongs;
the address of a gateway.

Other parameters are available for the specific needs of the applications. In general, the configuration of all these parameters is done automatically on the basis of a DHCP protocol and of a DHCP server (“Dynamic Host Configuration Protocol” RFC 3361).

A DHCP server allows an IP station to automatically receive, on each start-up, the parameters required for its operation in the IP network. By “start-up”, is understood the physical and/or radio linking of the station to the IP network. The use of such a server allows automated management of the network, and therefore the mass deployment of telephone sets on the existing IP network as well as their maintenance. Automatic configuration of the IP parameters in fact avoids the need to have to enter onto the keypad of each telephone set the IP information which forms the parameters of its lease.

When an IP station is linked to an IP network administered by a DHCP server, it receives a unique IP address. Such an address is allocated to it dynamically. The allocation of this IP address is dependent in particular on the IP addresses available in the network at the moment at which the allocation is performed. On the other hand, such an address does not depend on the physical link-up used by the IP station.

Consequently, it is not possible to determine a geographical location of an IP station on the basis of its IP address. Now, this IP address is the address which transits over the IP network and which makes it possible to identify the station in this network.

This characteristic may raise certain problems when the IP network and the public telephony network are interconnected.

Specifically, in certain countries, an emergency call number makes it possible to request help in the case of an emergency via the telephony network. Thus, when a user keys in such a number, he accesses an emergency service which is able to determine the geographical location of the caller so as to be able to organize the dispatching of aid. To do this, generally, equipment of the emergency service receives a message comprising the geographical location of the caller.

In a conventional telephone network, each fixed telephone number corresponds directly to a geographical location corresponding to the point of physical link-up to the telephone network. Thus, a caller calling from a fixed telephone can readily be located directly via the number of the telephone from which he is calling.

On the other hand, it is more complex to locate a caller who is using an IP station identified by its IP address. Specifically, the identification of each IP station in the IP network via an IP address allocated dynamically renders the problem of the locating of an IP station complex, as stated previously. The problem is aggravated by the mobility of the IP stations.

Now, when a user dials an emergency call number from an IP station, it is important to provide a geographical location to the equipment of the emergency service, making it possible to locate the caller. Certain national laws even demand such a characteristic before authorizing the connection of any private network to the public telephony network. Thus, the emergency call number 911 is known in the United States.

To respond to such a request, the network equipment manufacturer Cisco has proposed a solution making it possible to send the emergency equipment a message comprising the geographical location of the caller. However, this solution relies on the implementation of a proprietary protocol called CDP (“Cisco Discovery Protocol”). In such a solution, each switch has a given geographical location and knows an identifier of the equipment which is connected to each of its ports.

Thus, when starting up, the IP station uses the CDP proprietary protocol to register its identification on a Cisco switch. The latter then sends the IP station its own geographical location. Next, when the IP station registers with a call server, the station sends it the geographical location of the Cisco switch. The call server then registers this address in its call database.

In this way, when the IP station dials the emergency call number, it sends a communication request message to the call server. On receipt of this message, the call server searches through its database for the geographical location corresponding to the IP station then sends another communication request in the public telephony network, this request comprising the geographical location of the Cisco switch.

A solution of this type is based on the use of a proprietary protocol and therefore comprises numerous drawbacks. In particular, this solution requires the use of Cisco equipment from end to end in the IP network.

The invention aims to remedy these drawbacks.

For this purpose, a first aspect of the invention proposes a method of starting a station in a packet switching data transmission network on the one hand, and in a public telephone network on the other hand.

The data transmission network and the public telephone network are interconnected via a call server.

The data transmission network comprises an administration server, a plurality of subnets administered by the administration server and a plurality of stations, each linked to one of the subnets.

The administration server stores in memory a respective location information for each of the subnets.

The method comprises the steps according to which:
/a/ a determined station emits a lease request, destined for the administration server administering the subnet to which the station is linked;
/b/ the station receives from the administration server, in response to the lease request, a lease containing the respective stored location information of the subnet to which the station is linked;
/c/ the station emits, destined for the call server, a registration request comprising an identifier of the determined station as well as the location information;
/d/ on receipt of the registration request, the call server stores in a call database a information associating the identifier of the station and the location information.

By virtue of these provisions, after an exchange of messages with the administration server, then a registration with the call server, the latter knows the geographical position of the station.

In step /b/, the station can store the location information on receipt of the lease.

In an embodiment of the present invention, the administration server manages a respective database for each of the subnets. Advantageously, the respective location information of a subnet is stored in the respective database.

The location information of each of the subnets may correspond to a geographical location of a reference point of the subnet, and each subnet may be defined in such a way that the maximum distance between a station of the subnet and the reference point is less than a predetermined distance.

In an embodiment of the present invention, the location information corresponds to a geographical location of a reference point of the subnet and the location information transiting through the transmission network, from the administration server to the station and/or from the station to the call server corresponds to this geographical location. The location information can thus be made to transit through the data transmission network unencyphered.

It can also be made to transit through the transmission network from the administration server to the station and/or from the station to the call server in a form coded according to a code which is available for the call server.

In an embodiment, the administration server and the station implement the DHCP protocol, and steps /a/ to /d/ are carried out via the DHCP protocol.

A second aspect of the invention relates to a system comprising a packet switching data transmission network on the one hand, and a public telephone network on the other hand, and a call server interconnect the networks.

The transmission network comprises an administration server, a plurality of subnets administered by the administration server and a plurality of stations, each linked to one of the subnets.

The administration server comprises:
a memory suitable for storing a respective location information for each of the subnets;
a reception unit suitable for receiving a lease request from a station;
an emitting unit suitable for emitting to a station, in response to a lease request received from the station, a lease containing the respective stored location information of the subnet to which the station is linked.

The station comprises:
an emitting unit suitable for emitting to the administration server in the subnet to which the unit is linked, a lease request;
a reception unit suitable for receiving from the administration server in response to the lease request, a lease containing the respective stored location information of the subnet to which the station is linked; and
an emitting unit suitable for emitting to the call server, a registration request comprising an identifier of the station and the location information.

The call server comprises:
a reception unit suitable for receiving the registration request from the station; and
a memory for storing in a call database a information associating the identifier of the station and the location information, on receipt of the registration request.

In such a system, the station can furthermore comprise a memory suitable for storing the location information received from the administration server.

A third aspect of the invention relates to an administration server as defined in the second aspect of the invention.

A fourth aspect of the invention relates to a station as defined in the second aspect of the invention.

A fifth aspect relates to a method of setting up a telephone call from a registered station to a call server intended to interconnect, on the one hand a packet switching data transmission network, and on the other hand a public telephone network.

The station is started according to the first aspect of the invention.

The method comprises the steps according to which:
the station emits a first telephone call request to the call server;
the call server receives the first request;
a location information for the station is determined using the call database;
the call server emits a second call request from on the public telephone network, the second call request comprising the location information.

The invention covers stations of any type in the data transmission network.

The packet switching data transmission network is for example a local area network (LAN). The subnets are for example VLANs (“Virtual LANs”).

Other characteristics and advantages of the invention will become further apparent on reading the description which follows. The latter is purely illustrative and should be read in conjunction with the appended drawings in which:

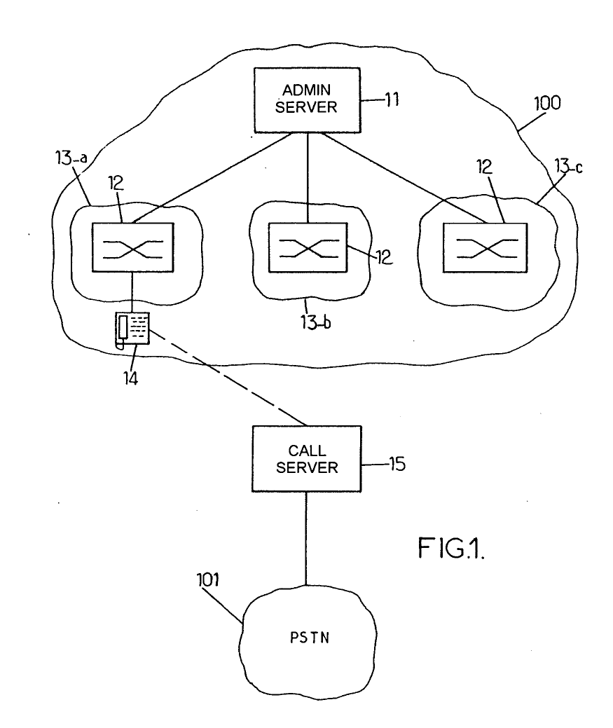

FIG. 1 is a diagram of an exemplary architecture for interconnecting networks between a packet switching data transmission network and a public telephony network;

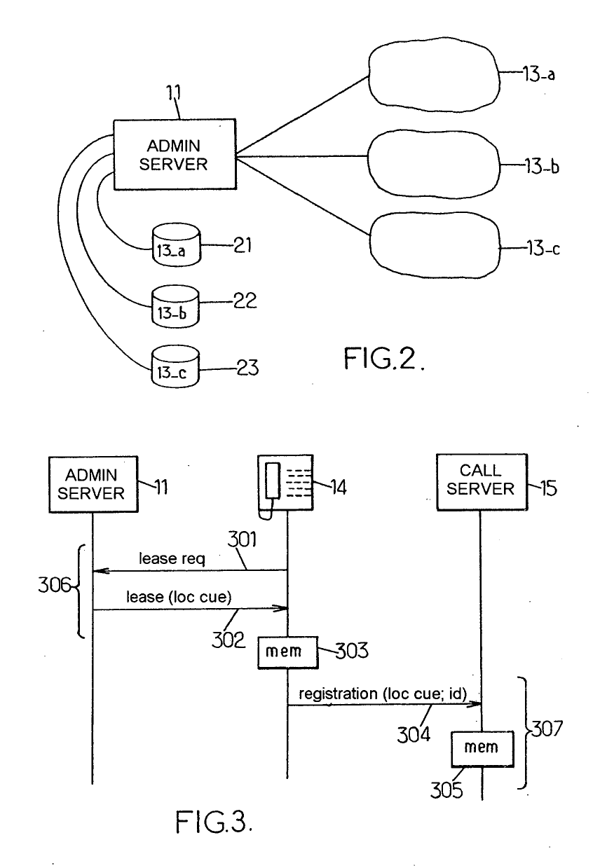

FIG. 2 is a diagram illustrating a management of subnets by the administration server according to an embodiment of the present invention;

FIG. 3 is a time chart of the exchanging of messages of an exemplary implementation of the method of registering a station according to the invention;

FIG. 4 is a time chart of exchanges of messages of an exemplary implementation of the method of setting up a call according to the invention;

FIG. 5 illustrates an architecture of such a network in an embodiment of the invention; and

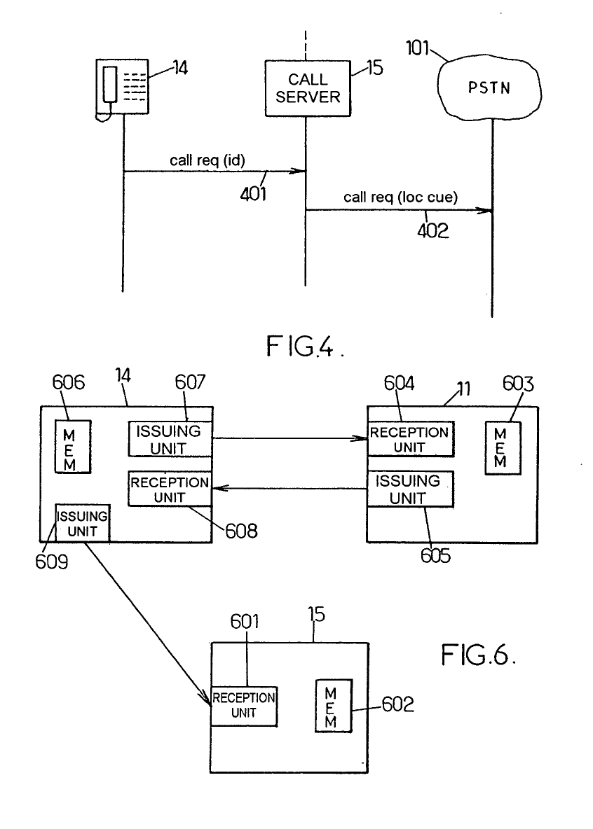

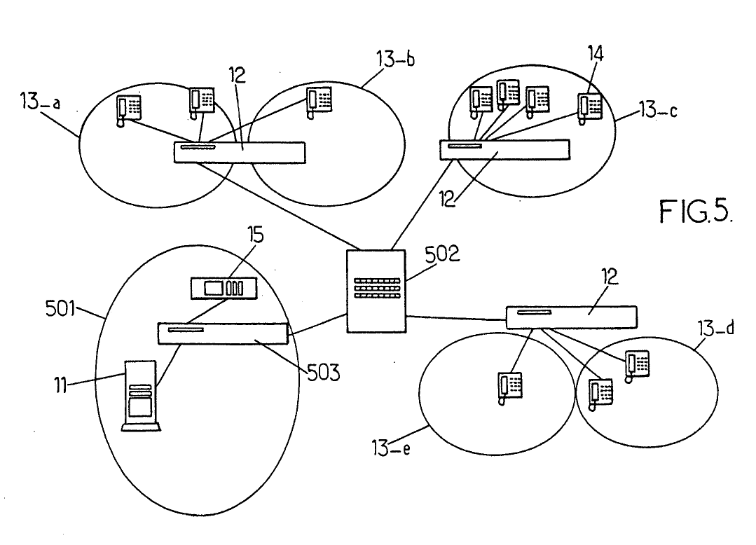

FIG. 6 is a diagram of various units included in the various devices of a system according to an embodiment of the present invention.

Represented diagrammatically in FIG. 1 is an exemplary architecture for interconnecting networks between a packet switching data transmission network 100, in particular an IP network of LAN type, and a public telephony network 101 (“PSTN”, standing for “Public Switched Telephone Network”).

In what follows, the data transmission network 100 is referenced as an IP network, without thereby limiting the invention.

In the following sections of the description, the administration server 11 corresponds to a DHCP server.

The IP network 100 comprises a DHCP administration server 11 intended to provide the parameters useful to the stations for their operation, and in particular to allocate addresses for the stations which register at the network. For an IP network, such a server may in particular be a DHCP server so as to allocate IP addresses to the IP stations which register. The IP network 100 is composed of several subnets 13-a, 13-b, 13-c, each comprising a group of the stations 14.

Moreover, stations 14 are connected to a call server 15. Such a server is equipment for interconnecting between the network 100 and the network 101. Thus, a station 14 of the network 100 can access this call server so as to be able to reach terminals of the public telephony network 101. For this purpose, the call server preferably comprises functionalities of a PABX (standing for “Private Automatic Branch Exchange”).

In an embodiment of the present invention, the stations 14 comprise PCs and telephone sets (IP telephones). The telephone sets may be dedicated sets or telephone sets emulated on a computer.

In principal, each station 14 is physically linked to the IP network by way of a respective physical access port. This physical access port may then be assigned to a subnet 13 included in the IP network 100.

Thus, by way of the physical port to which the station is linked, it is possible to determine the subnet to which the station belongs.

Each station of one and the same subnet may be linked to a switch 12.

In such an architecture, a station 14 which connects up to a physical port of a determined subnet requests firstly, from the DHCP server 11, the parameters that it needs for its operation in the network 100. This registration phase corresponds to a start-up in the IP network. It is commonly called “IP boot” in the jargon of the person skilled in the art.

According to an embodiment of the present invention, the administration server stores a location information for each of the subnets of the IP network 100. Such an association between a location information and a subnet may be carried out per configuration.

Generally, a DHCP server manages a distinct database per subnet 13. It is then advantageous to store the location information relating to a subnet in the respective database managed by the DHCP server. Such databases are commonly referenced by the term “scope” according to the jargon of the person skilled in the art.

Each of these scopes preferably comprises the whole set of leases relating to the stations of the respective subnet.

FIG. 2 illustrates such an architecture in which the administration server, or DHCP server, manages a database per subnet. Thus, a database 21 corresponds to the parameters of the subnet 13-a, a database 22 corresponds to the parameters of the subnet 13-b and a database 23 corresponds to the parameters of the subnet 13-c.

In an embodiment of the present invention, such subnets are advantageously defined as a function of geographical parameters. Thus, as a function of the accuracy with which one wishes to locate a station in the IP network 100, the physical connection ports of the stations which belong to the same subnet are determined.

The location information for a subnet may relate to any geographical location included in the subnet. It is thus possible to base oneself on the geographical location of a switch 12 in the subnet. In this case, if one wishes for example to locate a station 14 to within 60 meters, this subnet comprises the physical ports which are a maximum of 60 m distant from the switch 12 taken as geographical reference.

To summarize, at this stage, a respective geographical location is assigned to each subnet and each subnet is defined as a function of the distances between the physical ports and this respective reference geographical location. Such assignments are advantageously stored on the administration server.

A station 14 which connects up to a physical port of a subnet defined as previously has a first phase of start-up in the IP network 100. This first phase 306 is illustrated in FIG. 3.

In this IP boot phase, the station 14 requests the parameters that it needs for operation in the IP network 100.

The time chart, represented in FIG. 3, for the exchanges of messages illustrates an exemplary implementation of the method of registering a station with the administration server 11 according to an embodiment of the present invention.

At this stage, the station 14 has no knowledge of its IP address or of parameters required for operation in the IP network 100.

The station 14 emits a lease request 301 to the administration server 11. The administration server 11 responds to this request by emitting a lease 302 to the station 14. In an embodiment of the present invention, the lease advantageously comprises the location information assigned to the subnet to which the station 14 is linked.

This exchange of message may be carried out via the DHCP protocol. On receipt of the lease request, the administration server then allocates an IP address to the station 14 which it transmits to it in the lease 302. The DHCP server also sends the IP address of the call server 15 with which the station 14 can register so as to operate with the public telephony network 101.

On receipt of the lease 302, the station 14 stores in particular the location information received, in step 303.

At this stage, the IP boot-up of the station 14 is carried out and the station 14 is capable of operating on the IP network 100.

In the case where the station 14 wishes to set up telephone communications, a phase of start-up 307 on the PSTN network 101 is initiated. Thus, in an embodiment of the present invention, the station 14′ registers with the call server 15.

For this purpose, it emits to the call server 15, a registration message 304 comprising in particular an identifier of the station 14 as well as the location information stored in step 303.

On receipt of this message 304, the call server 15 stores in a call database, in step 305, a information associating the identifier of the station and the location information.

The identifier of the station may advantageously be the IP address allocated to it in the phase of start-up in the IP network 100.

It is important to note that the phase of start-up 306 in the IP network 100 may be carried out on the basis of the DHCP protocol. Specifically, in the latest version of the DHCP protocol, a lease comprises 64 fields. Out of these fields, 63 are predefined and one field presents a length, a content and a syntax that is free which are to be defined by the users of the protocol.

Consequently, such a field may be used to transmit to the station 14 a lease comprising the location information assigned to the subnet to which it is linked.

It is therefore possible to carry out this IP boot phase while remaining compatible with the DHCP protocol. One thus advantageously avoids the use of proprietary protocols and all the drawbacks stemming therefrom.

At this stage, the station 14 is capable of operating in the IP network 100 and capable of connecting up to the public telephony network 101.

Thus, the station 14 can request the setting up of a call. FIG. 4 illustrates an example of such a call initialization.

The station 14 emits a call request 401 comprising at least the identifier contained in the registration message 304. On receipt of this message 401, the call server 15 emits another call request 402 via a protocol of the public telephony network 101, into which request it enters the location information associated with the identifier of the station 14 in a call database.

In this way, the public telephony network 101 knows the geographical location of the station 14.

Generally, the call server enters the location information for the official numbers as defined previously. Thus, it is possible to locate the caller who keyed in such a telephone number so as to aid him.

Preferably, the location information entered into the call request emitted on the public telephony network meets the national requirements as to the format in which they must transit.

On the other hand, the location information which transits through the IP network 100 may be in any form. Thus, the location information may be stored by the administration server 11 in a coded form. Then it can transit through the IP network from the administration server 11 to the station 14 in this same coded form. The station 14 can thus store this information in coded form and send it to the call server 15 in this form also. In this case, the call server has the code and is then capable, on receipt of a call request received from the station, of decoding this location information so as to send it over the public telephony network 101 in a format compatible with the national requirements.

The packet switching data transmission network 100 corresponds to a conventional IP network well known to the person skilled in the art. The previous sections did not detail the architecture of such a network.

FIG. 5 illustrates an architecture of such a network in an embodiment of the invention.

In such an architecture, the IP network 100 is composed of five subnets 13-a to 13-e, respectively having a subnet mask 10.1.1.0, 10.1.2.0, 10.1.3.0, 10.1.4.0 and 10.1.5.0. Each of these subnets comprises stations 14 and is connected to a switch 12 which switches the data packets at level 2 (link layer of the OSI reference model). Then each switch 12 is connected to an IP switch 502 which is suitable for routing at the IP level the traffic of data received from the switches 12. Such an IP switch, or IP router, is in particular used to transmit the messages of the DHCP protocol destined for the DHCP server 11. For this purpose, this IP switch 502 implements the DHCP Relay protocol to relay to the DHCP server the DHCP requests emitted on the subnets 13.

In the example illustrated, the subnets correspond to the physical ports placed in a building. Thus, in particular, the subnet 13-a corresponds to the first storey of the right wing of the building 1, the subnet 13-b corresponds to the third storey of the left wing of the building 1.

Then, one and the same subnet 501 of mask 10.2.1.0 comprises the call server 15 as well as the DHCP server 11 connected via a switch 503 to the subnets 13.

In such an architecture, an embodiment of the invention may be applied.

FIG. 6 is a diagram of various units included in the various devices of a system according to an embodiment of the present invention.

Thus, an administration server 11 according to an embodiment of the present invention comprises:
a memory 603 suitable for storing a respective location information for each of the subnets;
a reception unit 604 suitable for receiving a lease request from a station;
an emitting unit 605 suitable for emitting to a station, in response to a lease request received from the station, a lease containing the respective stored location information of the subnet to which the station is linked.

It is noted that the units 604 and 605 form an interface in the IP network 100 with the stations of the network. Advantageously, the DHCP protocol is used on this interface as described previously.

Next, a station according to an embodiment of the present invention comprises:
an emitting unit 607 suitable for emitting to the administration server in the subnet to which the unit is linked, a lease request;
a reception unit 608 suitable for receiving from the administration server in response to the lease request, a lease containing the respective stored location information of the subnet to which the station is linked; and
an emitting unit 609 suitable for emitting to the call server, a registration request comprising an identifier of the station and the location information.

It is noted that the units 607 and 608 form an interface of the station with the administration server 11. Such an interface is therefore preferably effected according to the DHCP protocol. The station can also comprise a memory 606 for storing the location information received during the IP boot phase.

Then, a call server according to an embodiment of the present invention comprises:
a reception unit 601 suitable for receiving a registration request from a station of the I-P network; and
a memory 602 for storing in a call database a information associating an identifier of a station and a location information, on receipt of a registration request.

Of course, an embodiment of the invention may be applied to an application other than that of the locating of a caller keying in an emergency number.

The invention advantageously makes it possible to locate an IP station which attempts to initiate a call with a set of a public telephony network, from an IP-type data transmission network.

The implementation in an IP network using the DHCP protocol is easy and inexpensive. Specifically, it suffices to configure the DHCP server in such a way as to associate a geographical location and a subnet. By using the free field of the current version of the protocol, it is easy to transmit the corresponding geographical location to a station during its IP boot phase.

Then, during its telephone boot phase, this station is able to provide the call server with this information which it stores in its call database.

Next, according to the call requests and as a function of the public telephone network, the call server is capable of entering the location information which it has received during the station's telephone boot phase.

Advantageously, such a solution making it possible to preserve compatibility with the DHCP protocol, offers operators great freedom as to their choice of equipment suppliers.

1. A method of starting a station (14) in a packet switching data transmission network (100) on the one hand, and in a public telephone network (101) on the other hand;
said data transmission network and said public telephone network being interconnected via a call server (15);
the data transmission network comprising an administration server (11), a plurality of subnets (13-a, 13-b, 13-c) administered by said administration server and a plurality of stations (14), each linked to one of said subnets;
according to which the administration server stores in memory a respective location information for each of the subnets;
the method comprising the steps according to which:
/a/ a determined station emits a lease request (301), destined for the administration server administering the subnet to which said station is linked;
/b/ the station receives from the administration server, in response to said lease request, a lease (302) containing the respective stored location information of the subnet to which said station is linked;
/c/ the station emits, destined for the call server, a registration request (304) comprising an identifier of said determined station as well as the location information;
/d/ on receipt of the registration request, the call server stores (305) in a call database a information associating the identifier of the station and the location information.

2. The method of claim 1, wherein, in step /b/, the station stores (303) the location information on receipt of the lease.

3. The method of claim 1, wherein the administration server manages a respective database for each of said subnets, and wherein the respective location information of a subnet is stored in the respective database.

4. The method of claim 1, wherein the location information of each of the subnets corresponds to a geographical location of a reference point of the subnet, and
wherein each subnet is defined in such a way that the maximum distance between a station of said subnet and the reference point is less than a predetermined distance.

5. The method of claim 1, wherein the location information corresponds to a geographical location of a reference point of the subnet and wherein the location information transiting through the transmission network, from the administration server to the station and/or from the station to the call server corresponds to said geographical location.

6. The method of claim 5, wherein the location information transiting through the transmission network from the administration server to the station and/or from the station to the call server corresponds to said geographical location coded according to a code which is available for the call server.

7. The method of claim 1, according to which the administration server and the station implement the DHCP protocol, and
according to which steps /a/ to /d/ are carried out via the DHCP protocol.

8. A system comprising a packet switching data transmission network (100) on the one hand, and a public telephone network (101) on the other hand, and a call server (15) interconnecting said networks;
the transmission network comprising an administration server (11), a plurality of subnets (13-a, 13-b, 13-c) administered by said administration server and a plurality of stations (14), each linked to one of said subnets;
said administration server comprising:
a memory (603) suitable for storing a respective location information for each of the subnets;
a reception unit (604) suitable for receiving a lease request from a station;
an emitting unit (605) suitable for emitting to a station, in response to a lease request received from the station, a lease containing the respective stored location information of the subnet to which the station is linked;
said station comprising:
an emitting unit (607) suitable for emitting to the administration server in the subnet to which said unit is linked, a lease request;
a reception unit (608) suitable for receiving from the administration server in response to said lease request, a lease containing the respective stored location information of the subnet to which the station is linked; and
an emitting unit (609) suitable for emitting to the call server, a registration request comprising an identifier of the station and said location information; and
said call server comprising:
a reception unit (601) suitable for receiving said registration request from the station; and
a memory (602) for storing in a call database a information associating said identifier of the station and said location information, on receipt of the registration request.

9. The system of claim 8, wherein the station furthermore comprises a memory (606) suitable for storing the location information received from the administration server.

10. An administration server as defined in claim 8.

11. A station as defined in claim 8.

12. A method for establishing a telephone call from a station (14) registered to a call server (15) intended to interconnect, on the one hand a packet switching data transmission network (100), and on the other hand a public telephone network (101), said station being started acoording to the method of claim 1;
the method comprising the steps wherein:
the station emits a first telephone call request to the call server;
the call server receives said first request;
a location information for the station is determined using the call database;
the call server emits a second call request from on the public telephone network, said second call request comprising the location information.
